(19) United States
(12) Patent Application Publication
(10) Pub. No.: US 2022/0327668 A1
(43) Pub. Date: Oct. 13, 2022

(54) FINGERPRINT SENSING MODULE AND FINGERPRINT SENSING METHOD

(71) Applicant: Egis Technology Inc., Hsinchu City (TW)

(72) Inventors: Kuan-Yi Lin, Hsinchu City (TW); Tong-Long Fu, Hsinchu City (TW)

(73) Assignee: Egis Technology Inc., Hsinchu City (TW)

(21) Appl. No.: 17/613,929

(22) PCT Filed: Feb. 27, 2020
(86) PCT No.: PCT/CN2020/076921

§ 371 Date: Nov. 23, 2021

Related U.S. Application Data
(60) Provisional application No. 62/864,526, filed on Jun. 21, 2019.

(51) Int. Cl. G06T 5/00; G06V 40/13; G06V 40/12

(52) U.S. Cl. CPC G06T 5/002; G06V 40/1318; G06V 40/1365; G06T 2207/20224; G06T 2207/30204; G06T 2207/30196

(57) ABSTRACT

The present invention relates to a fingerprint sensing module suitable for being configured below a display module, and comprising a plurality of sensing elements and a signal processor. The display module projects a background beam and a marking beam to a finger pressed onto the display module. The plurality of sensing elements sense a fingerprint image generated after the background beam and the marking beam are reflected by the finger and pass through the display module. The signal processor is electrically connected to the plurality of sensing elements, and converts the fingerprint image into a corrected fingerprint image by using a corrected image. The present invention also relates to a fingerprint sensing method.

### BACKGROUND

### Technical Field

This disclosure relates to a sensing module and a sensing method, and in particular to a fingerprint sensing module and a fingerprint sensing method.

### Description of Related Art

Most of the existing under-screen optical fingerprint recognition solutions are applicable to an organic light-emitting diode (OLED) display panel, which main principle is to combine a visible light image capturing module with an organic light-emitting diode display panel, and use transparency of the organic light-emitting diode display panel itself to obtain a fingerprint in a manner similar to “photographing”.

As for the image capturing module located under the organic light-emitting diode display panel, when a complementary metal oxide semiconductor (CMOS) photosensitive element captures fingerprint ridges on the screen, it is inevitable that an image of a display module circuit inside the organic light-emitting diode display panel is also captured, causing the captured fingerprint sensing image to contain image noise, which results in poor image quality and difficulty in completing fingerprint recognition.

Furthermore, the display panel also deforms after being pressed by the finger, causing the sensed fingerprint image to be deformed too, thereby reducing credibility of the obtained fingerprint image.

### SUMMARY

This disclosure provides a fingerprint sensing module and a fingerprint sensing method, which has a good fingerprint sensing function.

The fingerprint sensing module according to an embodiment of the disclosure is suitable for being configured below a display module. The fingerprint sensing module includes multiple sensing elements and a signal processor. The display module projects a background beam and a marking beam to a finger pressed onto the display module. The multiple sensing elements sense a fingerprint image generated after the background beam and the marking beam are reflected by the finger and pass through the display module. The signal processor is electrically connected to the multiple sensing elements. The signal processor uses a corrected image to convert the fingerprint image into a corrected fingerprint image.

The fingerprint sensing method according to an embodiment of the disclosure includes the following steps. A background beam and a marking beam are provided by a display module. A fingerprint image is sensed by multiple sensing elements. The fingerprint image is generated after the display module projects the background beam and the marking beam to a finger pressed onto the display module, and the multiple sensing elements sense the background beam and the marking beam reflected by the finger and passing through the display module. And, a corrected image is used to convert the fingerprint image into a corrected fingerprint image beam.

Based on the above, since the fingerprint sensing module and the fingerprint sensing method according to the embodiment of the disclosure beam compare the corrected image with the fingerprint image to generate the corrected fingerprint image, the fingerprint sensing module and fingerprint sensing method according to the embodiment of the disclosure can reduce the image noise, reduce the impact of the display module being pressed, and obtain a better fingerprint image.

### BRIEF DESCRIPTION OF THE DRAWINGS

The accompanying drawings are included for further understanding of the disclosure, and the drawings are incorporated into this specification and constitute a part of this specification. The drawings illustrate the embodiments of the disclosure, and together with the descriptions serve to explain the principles of the disclosure.

FIG. 1 is a schematic diagram of a corrected image generated by a fingerprint sensing module according to an embodiment of the disclosure.

FIG. 2 is an example of a corrected image and a fingerprint image.

FIG. 3 is a schematic diagram of a fingerprint image generated by a fingerprint sensing module according to an embodiment of the disclosure.

FIG. 4 is an example of comparing the corrected image and the fingerprint image in FIG. 2 to generate a converted fingerprint image.

FIG. 5 is a flowchart of a fingerprint sensing method according to an embodiment of the disclosure.

### DESCRIPTION OF REFERENCE SIGNS OF THE ACCOMPANYING DRAWINGS

10: display module

12: display circuit

20: calibrator

100: fingerprint sensing module

120: signal processor

122: memory

200: background image

300, 300′: marked diagram

301, 301′: marking

500: corrected image

600: fingerprint image

700, 700′: fingerprint image

A: fingerprint sensing region

F: finger

F1, F2, F3, F4, F5, F6, F7, M1, M2, M3, M4, M5, M6, M7, P1, P2, P3, P4, P5, P6, P7: points

L1, L2: curve

N, N′: image noise

S1, S2, S3, S4, S5, S6, S7: sensing element

S100, S120, S140, S160: steps

### DESCRIPTION OF THE EMBODIMENTS

Reference will now be made in detail to exemplary embodiments of the disclosure, and examples of the exemplary embodiments are illustrated in the accompanying drawings. Whenever possible, the same reference numerals are used in the drawings and descriptions to indicate the same or similar parts.

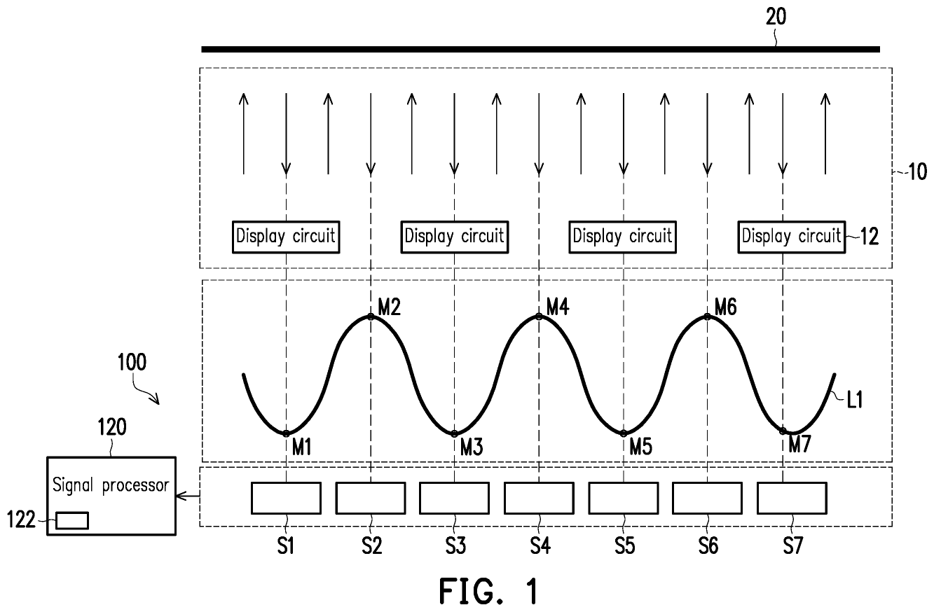

FIG. 1 is a schematic diagram of a corrected image generated by a fingerprint sensing module according to an embodiment of the disclosure. With reference to FIG. 1, a fingerprint sensing module 100 according to an embodiment of the disclosure is suitable for being configured below a display module 10. The fingerprint sensing module 100 includes multiple sensing elements S1, S2, S3, S4, S5, S6, and S7, and a signal processor 120. The display module 10 is, for example, an organic light-emitting diode display panel, an active-matrix organic light-emitting diode (AMOLED) display panel, or other suitable transparent display panels, which is not limited by the disclosure. In other embodiments, the display module 10 may also be a liquid crystal display panel. In addition, the display module 10 may include a display circuit 12. The display circuit 12 is, for example, a thin-film transistor (TFT) circuit layer formed by a semiconductor process or the like.

In the embodiment, the sensing elements S1, S2, S3, S4, S5, S6, and S7 may be a part of a sensor chip, for example, multiple pixels of the sensor chip. The sensor chip is, for example, a complementary metal oxide semiconductor (CMOS) image sensor chip or a charge coupled device (CCD) chip. For convenience of description, FIG. 1 simply shows the seven sensing elements S1, S2, S3, S4, S5, S6, and S7, but the disclosure is not limited thereto.

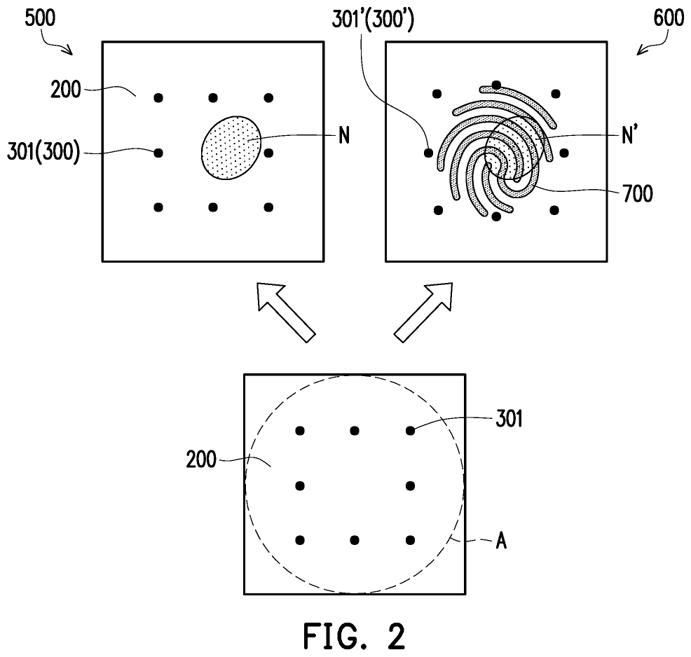

FIG. 2 is an example of a corrected image and a fingerprint image. With reference to FIGS. 1 and 2 concurrently, in this embodiment, the display module 10 projects a background beam and a marking beam to a calibrator 20 placed on the display module 10. The sensing elements S1, S2, S3, S4, S5, S6, and S7 sense a corrected image 500 generated after the background beam and the marking beam are reflected by the calibrator 20 and pass through the display module 10. The calibrator 20 is, for example, a white, or a black flat plate, or other flat plate with good reflectivity, but the disclosure is not limited thereto. Top left corner of FIG. 2 shows a background image 200 and a marked diagram 300. The corrected image 500 includes the background image 200 and the marked diagram 300, which respectively correspond to the images generated after the background beam and the marking beam are reflected by the calibrator 20 and pass through the display module 10. The background image 200 is, for example, a white image, a black image, an image of other colors, or other suitable images. The marked diagram 300 includes multiple markings 301, and the marking 301 may be a circle, an ellipse, or other suitable shapes. Each of the markings 301 may have a suitable color, and is not limited by the disclosure. For example, the marked diagram 300 may be a pattern of multiple black circles.

Bottom of FIG. 2 shows a fingerprint sensing region A. The fingerprint sensing region A is, for example, circular or other suitable shapes according to actual requirements. In the embodiment, the background beam and the marking beam may be projected from the fingerprint sensing region A of the display module 10, and a fingerprint image 600 is an image of a finger pressed onto the fingerprint sensing region A of the display module 10. However, the disclosure is not limited thereto, and a range of the fingerprint sensing region A may also be a range of the display module 10. That is, the fingerprint sensing module 100 and the fingerprint sensing method according to the embodiment of the disclosure are applicable to full-screen fingerprint sensing.

In the embodiment, the corrected image 500 may be stored in a memory 122 of the signal processor 120. In other words, the corrected image 500 is generated before the fingerprint sensing module 100 leaves the factory, and is stored in the memory 122 for the purpose of correcting the fingerprint image 600.

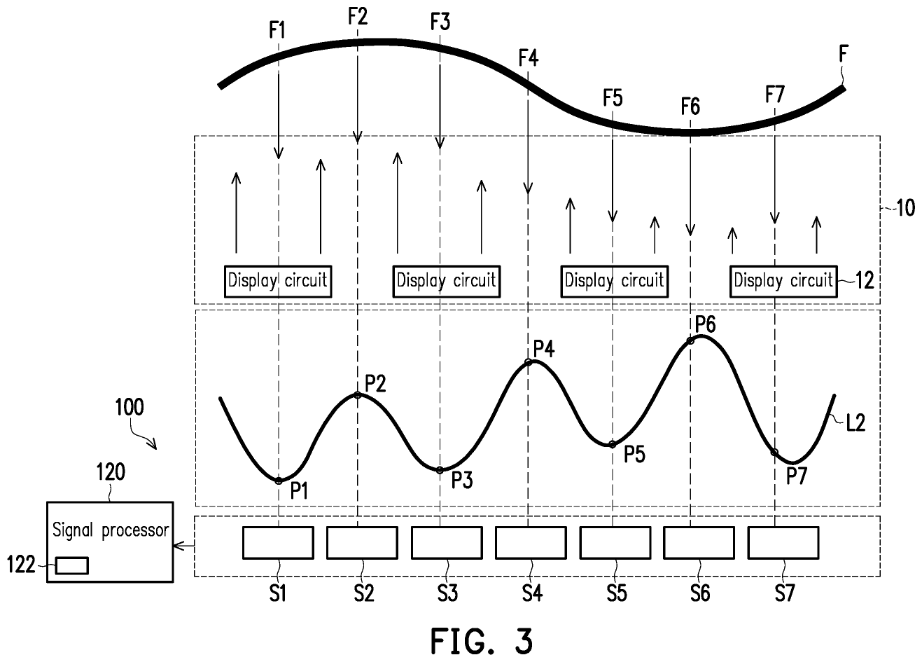

FIG. 3 is a schematic diagram of a fingerprint image generated by a fingerprint sensing module according to an embodiment of the disclosure. With reference to FIGS. 2 and 3 concurrently, in the embodiment, the display module 10 projects the background beam and the marking beam to a finger F pressed onto the display module 10. The sensing elements S1, S2, S3, S4, S5, S6, and S7 sense the fingerprint image 600 generated after the background beam and the marking beam are reflected by the finger F and pass through the display module 10. Top right corner of FIG. 2 shows the fingerprint image 600. The fingerprint image 600 includes a fingerprint image 700 and a marked diagram 300′, which respectively correspond to the images generated after the background beam and the marking beam are reflected by the finger F and pass through the display module 10. Compared with the corrected image 500 in the top left corner of FIG. 2, positions of markings 301′ in the marked diagram 300′ in the fingerprint image 600 are more or less different from the positions of the markings 301′ in the marked diagram 300 in the corrected image 500. A position difference between the markings 301′ and the markings 301 reflects a deformation of the display module 10 when it is being pressed. Therefore, the fingerprint sensing module 100 according to the embodiment of the disclosure uses the corrected image 500 to convert the fingerprint image 600 into a corrected fingerprint image, so that the fingerprint sensing function is good and credibility is improved.

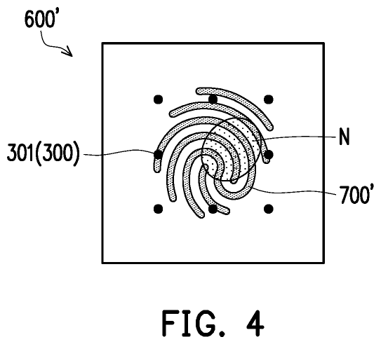

FIG. 4 is an example of comparing the corrected image and fingerprint image of FIG. 2 to generate a converted fingerprint image. With reference to FIGS. 2 and 4 concurrently, in the embodiment, the signal processor 120 compares a position of the marked diagram 300 in the corrected image 500 with a position corresponding to the marked diagram 300′ in the fingerprint image 600 generated after the marking beam is reflected by the finger F and passes through the display module 10, converts the fingerprint image 600 (such as the top right corner of FIG. 2) into a converted fingerprint image 600′ (such as FIG. 4), and then subtracts the corrected image 500 (such as the top left corner of FIG. 2) from the converted fingerprint image 600′, so as to generate a corrected fingerprint image. The converted fingerprint image 600′ includes a converted fingerprint image 700′. Alternatively, taking FIGS. 1 and as an example, the fingerprint image 600 may be shown by a curve L2 in FIG. 3, and the corrected image 500 may be shown by a curve L1 in FIG. 1. Therefore, the curve L2 may be converted into the converted fingerprint image 600′, and then the curve L1 may be subtracted, so that the fingerprint sensing module may obtain the corrected fingerprint image.

In another embodiment, after the signal processor 120 compares the position of the marked diagram 300 in the corrected image 500 with the position corresponding to the marked diagram 300′ in the fingerprint image 600 generated after the marking beam is reflected by the finger F and passes through the display module 10, the corrected image 500 may also be converted into a converted corrected image, and the converted corrected image may be subtracted from the fingerprint image 600, so as to generate the corrected fingerprint image. Taking FIGS. 1 and 3 as an example, the curve L1 may be converted into the converted corrected image, and then the converted curve L1 may be subtracted from the curve L2, so that the fingerprint sensing module may obtain the corrected fingerprint image.

Furthermore, with reference to FIGS. 1 to 3 again, in general, the corrected image 500 includes image noise N. The image noise N is, for example, an image projected by the background beam passing through the display circuit 12, or dirt, a fingerprint residue, etc. caused by the display module 10 being touched. A difference between image noise N′ and the image noise N in FIG. 2 is that the image noise N′ also reflects a degree to which the display module 10 is pressed by the finger F. Taking FIG. 1 as an example, the curve L1 shows the corrected image 500 in FIG. 2. The curve L1 penetrates the display circuit 12 of the display module 10 at positions corresponding to points M1, M3, M5, and M7. Therefore, compared to points M2, M4, and M6, light intensity of the curve L1 at the positions corresponding to the points M1, M3, M5, and M7 is lower. Deducing by analogy, in FIG. 3, the curve L2 penetrates the display circuit 12 of display module 10 at positions corresponding to points P1, P3, P5, and P7. Therefore, compared to points P2, P4, and P6, light intensity of the curve L2 at the positions corresponding to the points P1, P3, P5, and P7 is lower. Furthermore, in FIG. 3, positions of the finger F at points F5, F6, and F7 are ridges in the fingerprint, so that positions of the curve L2 at points P5, P6, and P7 may be positions of the fingerprint image 600 with higher brightness, and positions of the finger F at points F1, F2, F3, and F4 are furrows in the fingerprint, so that positions of the curve L2 at points Pl, P2, P3, and P4 are positions of the fingerprint image 600 with lower brightness. Therefore, after comparing the marked diagram 300 with the marked diagram 300′, the curve L2 may be converted into the converted L2, and then the curve L1 may be subtracted, so as to obtain the corrected fingerprint image. Alternatively, after comparing the marked diagram 300 with the marked diagram 300′, the converted curve L1 is subtracted from the curve L2, and the corrected fingerprint image may also be obtained.

In addition, in the embodiment, the signal processor 120 is electrically connected to the sensing elements S1, S2, S3, S4, S5, S6, and S7. The signal processor 120 is, for example, a central processing unit (CPU), a microprocessor, a digital signal processor (DSP), a programmable controller, a programmable logic device (PLD), or other similar devices, or a combination of these devices, but the disclosure is not limited thereto. In addition, in an embodiment, functions of the signal processor 120 may be implemented as multiple program codes. The program codes are stored in a memory 122, and the program codes are executed by the signal processor 120. Alternatively, in an embodiment, each function of the signal processor 120 may be implemented as one or more circuits. The disclosure does not limit usage of software or hardware to implement the functions of the signal processor 120.

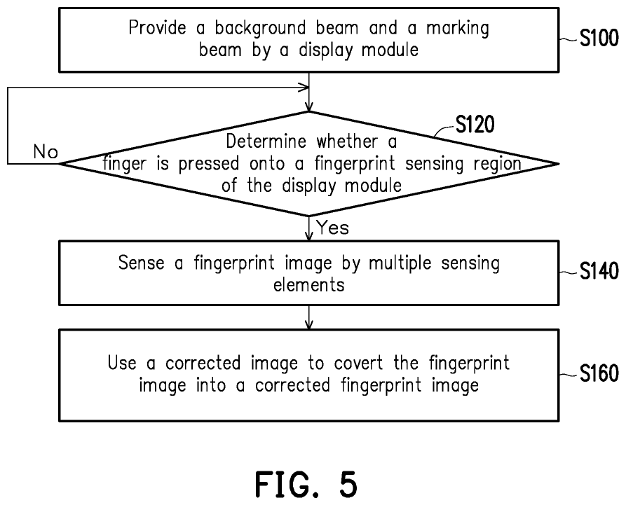

FIG. 5 is a flowchart of a fingerprint sensing method according to an embodiment of the disclosure. With reference to FIG. 5, the fingerprint sensing method according to an embodiment of the disclosure includes the following steps. The background beam and the marking beam are provided by the display module 10 in Step S100. The fingerprint image 600 is sensed by the multiple sensing elements S1, S2, S3, S4, S5, S6, and S7 in Step S140, wherein the fingerprint image 600 is generated after the display module 10 projects the background beam and the marking beam to the finger F pressed onto the display module 10, and the multiple sensing elements S1, S2, S3, S4, S5, S6, and S7 sense the background beam and the marking beam reflected by the finger F and passing through the display module 10. The corrected image 500 is used to convert the fingerprint image 600 into the corrected fingerprint image in Step S160, wherein the corrected image 500 is stored in the memory 122 of the signal processor 120. The corrected image 600 is generated after the display module 10 projects the background image 200 and the marked diagram 300 to the calibrator 20 placed on the display module 10, and the multiple sensing elements S1, S2, S3, S4, S5, S6, and S7 sense the background image 200 and the marked diagram 300 reflected by the calibrator 20 and passing through the display module 10.

In the embodiment, the fingerprint sensing method further includes determining whether the finger is pressed onto the fingerprint sensing region A of the display module 10 in Step S120.

In summary, since the fingerprint sensing module and fingerprint sensing method according to the embodiments of the disclosure compare the corrected image with the fingerprint image to generate the corrected fingerprint image, the fingerprint sensing module and fingerprint sensing method of the embodiments of the disclosure can reduce the image noise, and obtain a better fingerprint image. Furthermore, because the image noise includes the image projected by the background beam passing through the display circuit, dirt and the fingerprint residue caused by the display module being touched, deformation of the display module or the fingerprint sensing module deformation due to temperature changes, deformation of the display module after long-term usage, or image distortion such as distortion of the edge image due to the fingerprint sensing module (using a wide-angle lens) being pressed, therefore the fingerprint sensing module and the fingerprint sensing method according to the embodiments of the disclosure can use the above-mentioned method of generating the corrected fingerprint image, so that the obtained fingerprint image is good.

Finally, it should be noted that the above embodiments are only illustrations of the technical solutions of the disclosure, and are not meant to limit the disclosure. Although the disclosure has been described in detail with reference to the foregoing embodiments, those of ordinary skill in the art should understand that modifications may be made to the technical solutions described in the foregoing embodiments, or equivalent replacements of some or all of the technical features may be done, however, these modifications or replacements do not cause the essence of the corresponding technical solutions to deviate from the scope of the technical solutions according to the embodiments of the disclosure.

What is claimed is:

1. A fingerprint sensing module, suitable for being configured below a display module, comprising:
a plurality of sensing elements, wherein the display module projects a background beam and a marking beam to a finger pressed onto the display module, and the plurality of sensing elements sense a fingerprint image generated after the background beam and the marking beam are reflected by the finger and pass through the display module; and
a signal processor, electrically connected to the plurality of sensing elements, wherein the signal processor uses a corrected image to convert the fingerprint image into a corrected fingerprint image.

2. The fingerprint sensing module according to claim 1, wherein the corrected image is stored in a memory of the signal processor.

3. The fingerprint sensing module according to claim 1, wherein the signal processor compares a position of a marked diagram in the corrected image with a position corresponding to a marked diagram in the fingerprint image generated after the marking beam is reflected by the finger and passes through the display module, converts the corrected image into a converted corrected image, and then subtracts the converted corrected image from the fingerprint image to generate the corrected fingerprint image.

4. The fingerprint sensing module according to claim 1, wherein the signal processor compares a position of a marked diagram in the corrected image with a position corresponding to a marked diagram in the fingerprint image generated after the marking beam is reflected by the finger and passes through the display module, converts the fingerprint image into a converted fingerprint image, and then subtracts the corrected image from the converted fingerprint image to generate the corrected fingerprint image.

5. The fingerprint sensing module according to claim 1, wherein the background image and the marked diagram are projected from a fingerprint sensing region of the display module.

6. The fingerprint sensing module according to claim 1, wherein the fingerprint image is an image of the finger pressed onto a fingerprint sensing region of the display module.

7. A fingerprint sensing method, comprising:
providing a background beam and a marking beam by a display module;
sensing a fingerprint image by a plurality of sensing elements, wherein the fingerprint image is generated after the display module projects the background beam and the marking beam to a finger pressed onto the display module, and the plurality of sensing elements sense the background beam and the marking beam reflected by the finger and passing through the display module; and
using a corrected image to convert the fingerprint image into a corrected fingerprint image.

8. The fingerprint sensing method according to claim 7, wherein the corrected image is stored in a memory of a signal processor.

9. The fingerprint sensing method according to claim 7, wherein a method for generating the corrected fingerprint image comprises:
comparing a position of a marked diagram in the corrected image with a position corresponding to a marked diagram in the fingerprint image generated after the marking beam is reflected by the finger and passes through the display module, converting the corrected image into a converted corrected image, and then subtracting the converted corrected image from the fingerprint image to generate the corrected fingerprint image.

10. The fingerprint sensing method according to claim 7, wherein a method for generating the corrected fingerprint image comprises:
comparing a position of a marked diagram in the corrected image with a position corresponding to a marked diagram in the fingerprint image generated after the marking beam is reflected by the finger and passes through the display module, converting the fingerprint image into a converted fingerprint image, and then subtracting the corrected image from the converted fingerprint image to generate the corrected fingerprint image.

11. The fingerprint sensing method according to claim 7, further comprising:
determining whether the finger is pressed onto a fingerprint sensing region of the display module.

12. The fingerprint sensing method according to claim 7, wherein the background image and the marked diagram are projected from a fingerprint sensing region of the display module.
